(19) United States
(12) Patent Application Publication
(10) Pub. No.: US 2024/0070877 A1
(43) Pub. Date: Feb. 29, 2024

(54) IMAGE PROCESSING APPARATUS, METHOD FOR CONTROLLING THE SAME, IMAGING APPARATUS, AND STORAGE MEDIUM

(71) Applicant: CANON KABUSHIKI KAISHA, Tokyo (JP)

(72) Inventor: YOSHIE ITO, Chiba (JP)

(21) Appl. No.: 18/457,217

(22) Filed: Aug. 28, 2023

(30) Foreign Application Priority Data
Aug. 31, 2022 (JP) 2022-137539

(51) Int. Cl. G06T 7/20; G06T 7/62; G06T 7/70

(52) U.S. Cl. CPC G06T 7/20; G06T 7/62; G06T 7/70; G06T 2207/30242

(57) ABSTRACT

An image processing apparatus includes a memory device that stores a set of instructions, and at least one processor that executes the set of instructions to function as an acquisition unit configured to acquire an image, a detection unit configured to detect objects of different types, a main object determination unit configured to determine an object as a main object based on a result of the detection by the detection unit, and a tracking unit configured to track the object determined as the main object by the main object determination unit. In a state where the object being tracked is continuously detected by the detection unit, in a case where an object of a type different from a type of the object being tracked is detected in addition to the object being tracked, the main object determination unit re-determines which type of object is the main object.

### BACKGROUND OF THE DISCLOSURE

### Field of the Disclosure

The present disclosure relates to an image processing apparatus capable of re-selecting a main object from among a plurality of objects included in an image, an imaging apparatus including the image processing apparatus, a method for controlling the image processing apparatus, and a storage medium.

### Description of the Related Art

A conventional method for a digital camera is known to detect the face and eyes of a person from successively acquired image data and keep optimizing the focus state and exposure state of the detected face and eyes of the person. In recent years, using a machine learning technique has made it possible to detect various types of objects. This technique enables detecting a specific object by inputting images to a detector, together with dictionary data obtained by learning of the target object. The technique also enables detecting another object of a different type from the images by changing the dictionary data to be input to the detector.

In object detection using the dictionary data, “erroneous detection” may occur where an object that is supposed to be undetectable with the dictionary data is detected. Even in erroneous detection, no major issue will occur in tracking control as long as a focus adjustment target region of an object intended by the user is stably kept detected. However, in an erroneous detection state, a region of an object not intended by the user may be detected as the focus adjustment target region or the detection state may become unstable.

Japanese Patent Application Laid-Open No. 2021-132369 discusses a configuration in which all types of dictionary data are kept used even after an object is once detected and selected as a main object, and then, if an object is detected at least predetermined number of times in succession based on the same dictionary data, the object is re-selected as the correct main object.

However, if a region undesirable for focus adjustment is erroneously kept detected with a certain degree of stability, the conventional technique discussed in Japanese Patent Application Laid-Open No. 2021-132369 cannot correct the erroneous detection. If erroneous detection occurs in succession, the conventional technique may possibly change the main object by mistake.

### SUMMARY OF THE DISCLOSURE

The present disclosure has been made in consideration of the above situation, and is directed to an image processing apparatus and an imaging apparatus that are capable of detecting and tracking a main object while suppressing erroneous detection in a state where various types of objects are set as detection targets, and a method for controlling the image processing apparatus.

According to an aspect of the present disclosure, an image processing apparatus includes a memory device that stores a set of instructions, and at least one processor that executes the set of instructions to function as an acquisition unit configured to acquire an image, a detection unit configured to detect objects of different types, a main object determination unit configured to determine an object as a main object based on a result of the detection by the detection unit, and a tracking unit configured to track the object determined as the main object by the main object determination unit. In a state where the object being tracked is continuously detected by the detection unit, in a case where an object of a type different from a type of the object being tracked is detected in addition to the object being tracked, the main object determination unit re-determines which type of object is the main object.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an imaging apparatus according to an exemplary embodiment.

FIG. 2 is a flowchart illustrating processing according to the exemplary embodiment.

FIGS. 3A to 3C illustrate examples of a first scene and an example of an effect according to the exemplary embodiment.

FIGS. 4A to 4D illustrate an example of a method for comparing likelihoods of being a main object according to the exemplary embodiment.

FIGS. 5A to 5D illustrate examples of a second scene and another example of the method for comparing the likelihoods of being the main object according to the exemplary embodiment.

### DESCRIPTION OF THE EMBODIMENTS

Hereinafter, embodiments will be described in detail with reference to the attached drawings. Note, the following embodiments are not intended to limit the scope of the claimed disclosure, and limitation is not made to the disclosure that requires a combination of all features described in the embodiments. Two or more of the multiple features described in the embodiments may be combined as appropriate. Furthermore, the same reference numerals are given to the same or similar configurations, and redundant description thereof is omitted.

In an exemplary embodiment to be described below, a case using an imaging apparatus having an object detection function will be described. While a description is given taking an imaging apparatus as an example in the present exemplary embodiment, the present exemplary embodiment is not limited thereto but applicable to an image processing apparatus that receives image data obtained by the imaging apparatus and performs image processing.

Examples of such an imaging apparatus and such an image processing apparatus include a digital camera, a video camera, computer devices (e.g., a personal computer, a tablet computer, a media player, and a personal digital assistant (PDA)), a mobile phone, a smartphone, a game machine, a robot, a drone, and a drive recorder. These are merely examples, and the present exemplary embodiment is also applicable to any other image processing apparatus.

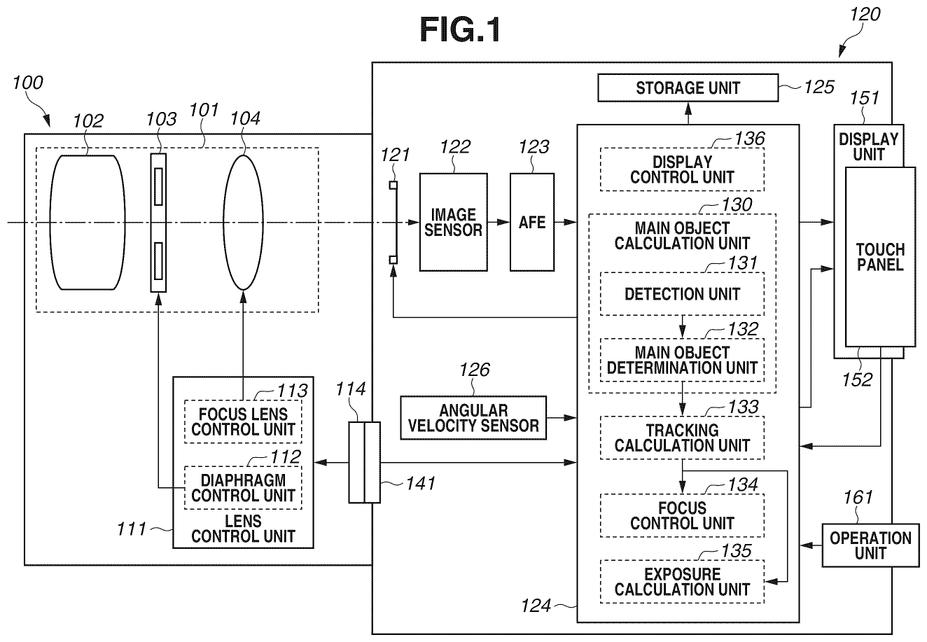

FIG. 1 is a block diagram illustrating a schematic functional configuration of an imaging apparatus according to the present exemplary embodiment.

Referring to FIG. 1, the imaging apparatus having an object detection function includes a main body unit 120 and a lens unit 100 attachable to and detachable from the main body unit 120.

The lens unit 100 includes an imaging optical system 101 including a main optical system 102, a diaphragm 103, and a focus lens group 104. A focal length (an angle of view) of the imaging optical system 101 may be variable. The lens unit 100 also includes components for detecting the positions of the diaphragm 103 and movable lenses (e.g., the focus lens group 104, a zoom lens, and an image stabilizing lens) and components for driving these elements.

The focus lens group 104 may include a plurality of focus lenses or only one focus lens. While FIG. 1 illustrates a fixed focal length lens as an example of an interchangeable lens for simplification, a lens (a zoom lens) with a variable focal length can also be used.

The lens unit 100 also includes a lens control unit 111 that controls the operation of the lens unit 100. The lens control unit 111 includes a memory for storing programs and a processor that can execute the programs.

The lens control unit 111 causes the processor to execute the programs to control the operation of the lens unit 100 and communicate with the main body unit 120 via mount contact portions 114 and 141 (described below). A diaphragm control unit 112 and a focus lens control unit 113 are functional blocks representing functions implemented by the processor of the lens control unit 111 executing the programs.

The diaphragm control unit 112 controls an open area amount (an aperture value) of the diaphragm 103 under the control of the lens control unit 111. The diaphragm control unit 112 supplies the aperture value of the diaphragm 103 to the main body unit 120 via the lens control unit 111 in response to a request.

The focus lens control unit 113 drives the focus lens group 104 in the optical axis direction of the imaging optical system 101 to control the position of the focus lens group 104 under the control of the lens control unit 111. The focus lens control unit 113 supplies information about the position of the focus lens group 104 to the main body unit 120 via the lens control unit 111 in response to a request.

In a case where the imaging optical system 101 includes a zoom lens and an image stabilizing lens, the lens control unit 111 has a function of controlling the positions of these movable lenses.

The lens unit 100 and the main body unit 120 include mount units that engage with each other. The mount units include the mount contact portions 114 and 141 configured to be in contact with each other in a state where the lens unit 100 is attached to the main body unit 120. The lens unit 100 and the main body unit 120 are electrically connected to each other via the mount contact portions 114 and 141. Power for the operation of the lens unit 100 is supplied from the main body unit 120 via the mount contact portions 114 and 141. Also, the lens control unit 111 and a control and calculation unit 124 can communicate with each other via the mount contact portions 114 and 141.

The main body unit 120 includes a shutter 121 for exposure control and an image sensor 122 such as a complementary metal oxide semiconductor (CMOS) sensor.

The imaging optical system 101 forms an optical image on the imaging plane of the image sensor 122 provided in the main body unit 120. The image sensor 122 may be, for example, a general CMOS color image sensor. The shutter 121 is openably and closably provided between the imaging optical system 101 and the image sensor 122.

At the time of imaging, the shutter 121 is opened to expose the image sensor 122 to light. While the exposure control is performed using the shutter 121, the exposure control can also be implemented by the control of the image sensor 122 (using an electronic shutter). In this case, a configuration (without a mechanical shutter) where the shutter 121 is eliminated from the imaging apparatus may be used.

The image sensor 122 may be, for example, a known charge coupled device (CCD) or CMOS color image sensor including color filters arranged in a primary color Bayer array. The image sensor 122 includes a pixel array including a plurality of two-dimensionally arranged pixels, and peripheral circuits for reading signals from the pixels. Each of the pixels accumulates electric charge corresponding to an incident light quantity through photoelectric conversion. By reading, from each of the pixels, a signal having a voltage corresponding to the electric charge accumulated during an exposure period, a pixel signal group (an analog image signal) representing an object image formed on the imaging plane can be obtained.

The analog image signal is input to an analog front end (AFE) 123. The AFE 123 applies analog signal processing such as correlative double sampling and gain adjustment to the analog image signal, and outputs the resulting signal to the control and calculation unit 124.

The control and calculation unit 124 includes, for example, a memory for storing programs and a processor that can execute the programs. The control and calculation unit 124 causes the processor to execute the programs to control the operation of the main body unit 120 and implement various functions of the main body unit 120.

The control and calculation unit 124 causes the processor to execute the programs to communicate with the lens control unit 111. Examples of commands transmitted from the control and calculation unit 124 to the lens control unit 111 include a command for controlling the operation of the lens unit 100 and a command for requesting information about the lens unit 100. Based on a received command, the lens control unit 111 controls the operations of the focus lens group 104 and the diaphragm 103, or transmits the information about the lens unit 100 to the control and calculation unit 124. Examples of the information about the lens unit 100 transmitted to the control and calculation unit 124 include product information about the lens unit 100, and information about the positions of the movable lenses and the aperture value.

Referring to FIG. 1, function blocks 130 to 136 in the control and calculation unit 124 represent functions implemented by the processor of the control and calculation unit 124 executing the programs.

An operation unit 161 is a generic term representing input devices (e.g., a button, a switch, and a dial) provided for the user to input various instructions to the main body unit 120. The operation unit 161 includes at least one input device. The input devices included in the operation unit 161 have names corresponding to assigned functions. For example, the operation unit 161 includes a release switch, a moving image recording switch, an imaging mode selection dial for selecting an imaging mode, a menu button, an arrow key, and an enter key. One input device may serve as an operation system corresponding to a plurality of functions. The release switch is one of typical input devices (not illustrated) included in the operation unit 161. The release switch is used to record a still image. The control and calculation unit 124 recognizes the half-press state of the release switch as an imaging preparation instruction and the full-press state thereof as an imaging start instruction. In a state where the release switch is not pressed, the control and calculation unit 124 recognizes that the main body unit 120 is in an imaging standby state. Using the half-press state of the release switch as a trigger, the control and calculation unit 124 controls the components to perform a focus adjustment operation (described below) and an exposure control operation (described below). These operations are collectively referred to as “imaging preparations”.

When the moving image recording switch is pressed in the imaging standby state, the control and calculation unit 124 recognizes the press as a moving image recording start instruction. When the moving image recording switch is pressed during moving image recording, the control and calculation unit 124 recognizes the press as a moving image recording stop instruction. The function to be assigned to the same input device may be variable.

An angular velocity sensor 126 is, for example, a three-axis gyro sensor and outputs a signal representing the motion of the main body unit 120 to the control and calculation unit 124. The control and calculation unit 124 detects the motion of the main body unit 120 based on the signal output by the angular velocity sensor 126. The control and calculation unit 124 also performs predetermined control based on the detected motion of the main body unit 120.

A display unit 151 is a display device (a touch display) having a touch panel 152.

The display unit 151 functions as an electronic viewfinder (EVF) while the image sensor 122 continuously captures a moving image (successively acquiring image signals) and the display unit 151 continuously displays the captured moving image via the display control unit 136 (described below).

The display unit 151 can reproduce and display image data recorded in a storage unit 125, display information about the status and settings of the main body unit 120, and display a graphical user interface (GUI) such as a menu screen. By performing touch operations on the touch panel 152, the user can operate the displayed GUI and also specify a focal point detection region.

When the control and calculation unit 124 detects operations on the operation unit 161 and the touch panel 152, the control and calculation unit 124 operates based on the detected operations. For example, upon detection of an operation for a still image capturing preparation instruction, the control and calculation unit 124 causes the focus control unit 134 (described below) and the exposure calculation unit 135 (described below) to perform automatic focus (AF) processing and automatic exposure (AE) processing, respectively. Upon detection of an operation for a still image capturing instruction, the control and calculation unit 124 controls or performs processing for capturing a still image, processing for generating recording image data, and processing for recording the recording image data in the storage unit 125. The storage unit 125 may be a storage medium such as a memory card. In this case, the control and calculation unit 124 may be configured to communicate with the storage medium via a storage medium I/F (not illustrated) connecting the control and calculation unit 124 and the storage medium.

The control and calculation unit 124 applies predetermined image processing to the analog image signal input from the AFE 123 to generate a signal and image data and acquire and/or generate various types of information. The control and calculation unit 124 may be a dedicated hardware circuit designed to implement a specific function, such as an Application Specific Integrated Circuit (ASIC), or configured to implement a specific function when a programmable processor such as a Digital Signal Processor (DSP) executes software.

The image processing applied by the control and calculation unit 124 includes preprocessing, color interpolation processing, correction processing, detection processing, data modification processing, evaluation value calculation processing, and special effect processing. The preprocessing includes signal amplification, reference level adjustment, and defective pixel correction. The color interpolation processing, which is also referred to as demosaicing, is processing for interpolating color component values that are not acquired during imaging. The correction processing includes white balance adjustment, gradation correction, correction (image recovery) for image degradation due to optical aberration of the imaging optical system 101, correction for the influence of peripheral darkening due to the imaging optical system 101, and color correction.

The detection processing includes detection of feature regions (e.g., face and human body regions) and motions thereof, and person recognition processing. The data modification processing includes combination, scaling, encoding and decoding, and header information generation (data file generation). The evaluation value calculation processing includes the generation of signals and evaluation values to be used for AF detection, and the generation of evaluation values to be used for AE control. The special effect processing includes the application of a defocus effect, color tone modification, and re-lighting. These pieces of processing are examples of processing applicable by the control and calculation unit 124 and are not intended to limit the processing applied by the control and calculation unit 124. Although not illustrated in FIG. 1, processing circuits that perform the above-described image processing may be separately provided.

The main object calculation unit 130 in the control and calculation unit 124 illustrated in FIG. 1 is a function block having functions for object detection processing and main object determination which are implemented, for example, by the control and calculation unit 124 executing the programs. The main object calculation unit 130 in FIG. 1 includes the detection unit 131 and the main object determination unit 132. Unlike the example of FIG. 1, the main object calculation unit 130 may be provided separately from the control and calculation unit 124. Also in this case, the control and calculation unit 124 can execute the programs to cause the main object calculation unit 130 to perform the functions.

The detection unit 131 applies processing for detecting a plurality of predetermined types of objects to the image data to detect an object region for each type of object. As the detection method, any known method such as Adaptive Boosting (AdaBoost) or a convolution neural network technique can be used. Such a method can be implemented in the form of a program operating on a central processing unit (CPU), in the form of a dedicated hardware, or in the form of a combination of both. The detection unit 131 will be described below based on the premise that parameters for detecting an object region are stored as dictionary data for each type of object. The detection unit 131 can detect object regions for a plurality of types of objects by changing the dictionary data to be used in the detection processing. In other words, each dictionary data stores parameters corresponding to a different one of the plurality of types of objects.

The dictionary data can be generated in advance using a known method such as machine learning. The types of objects to be detected by the detection unit 131 are not particularly limited, but the present exemplary embodiment assumes that a result of the detection is used for object tracking. Thus, the detection unit 131 detects one or a plurality of types of movable objects among a human body, a vehicle (e.g., a motorcycle, an automobile, an electric car, an airplanes, or a ship), and an animal (e.g., a dog, a cat, or a bird). For a human body (an object of a second type), the detection unit 131 can also detect one or more specific body parts such as the head, body, or eyes. For a vehicle (an object of a first type), the detection unit 131 detects the whole body and one or more predetermined specific parts. For an animal, the detection unit 131 can detect the whole body and one or more specific body parts such as the face or eyes.

As a unit for detecting specific parts, an organ detection unit (not illustrated) may be provided in addition to the detection unit 131. In this case, the organ detection unit detects organ regions for an object region detected by the detection unit 131. For example, the organ detection unit detects organ regions, such as the face, eyes, nose, and mouth, for the object region of a human body detected by the detection unit 131. The organ detection unit can detect the face and the organs by using a known method based on feature parameters and templates. In a case where the detection unit 131 is configured to detect the above-described organs, the organ detection unit is unnecessary and excluded.

The detection unit 131 generates a detection result for each detection target object. While the detection result is assumed to include the total number of detected regions, and the position, size, detection reliability, and detection frequency of each of the regions, the present exemplary embodiment is not limited thereto. In a case where the organ detection unit is provided, the organ detection unit generates a detection result on the detected face region and organ regions for each detection target object. While the detection result is assumed to include the total number of detected regions, and the position, size, and detection reliability of each of the regions, the present exemplary embodiment is not limited thereto. The information acquired by the detection unit 131 is supplied to the main object determination unit 132 (described below).

In the present exemplary embodiment, pieces of processing by the detection unit 131 and the main object determination unit 132 in the main object calculation unit 130 are collectively referred to as object detection processing. The image data to be subjected to the object detection processing may be acquired by the image sensor 122 or read from the storage unit 125. The object detection processing is applicable to both still image data and moving image data.

The main object determination unit 132 determines a main object as an object to be subjected to tracking processing, based on a result of the object detection processing by the detection unit 131. The first determination on the main object is performed by using a known calculation method based on the position, the size, and the detection reliability. The calculation method will be described in detail below.

The tracking calculation unit 133 performs the tracking processing by using information about the main object set as the tracking target by the main object determination unit 132. The tracking processing may be performed by using any known method such as template matching. The method may be implemented in the form of a program operating on a CPU, in the form of a dedicated hardware, or in the form of a combination of both.

The focus control unit 134 calculates a control value for the focus lens group 104 so as to focus on a region of the main object (a main object region). A result of the calculation is transmitted to the lens control unit 111 via the mount contact portions 114 and 141, and is used by the focus lens control unit 113 to control the focus lens group 104. The focus control unit 134 can also perform calculations for applying focus adjustment not only to the main object region but also to a focal point detection region (an AF area) specified by the user via the touch panel 152 and a region set by the imaging apparatus.

The exposure calculation unit 135 calculates control values for the diaphragm 103 and the image sensor 122 so as to achieve correct exposure of the main object region. For example, a result of calculating the control value for the diaphragm 103 is transmitted to the lens control unit 111 via the mount contact portions 114 and 141, and is used by the diaphragm control unit 112 to control the diaphragm 103. The exposure calculation unit 135 can perform control to achieve optimum exposure conditions not only for the main object region but also for the entire image, and also calculate an exposure control value for a specific region specified by the user via the touch panel 152.

When, for example, the release switch of the main body unit 120 is half-pressed, the focus control unit 134 and the exposure calculation unit 135 perform calculations to perform the focus adjustment operation and the exposure control operation, respectively, for the main object under the control of the control and calculation unit 124. The focus control unit 134 and the exposure calculation unit 135 may perform the focus adjustment operation and the exposure control operation, respectively, for the main object determined by the main object determination unit 132 or the object being tracked by the tracking calculation unit 133, regardless of the release switch operation. The focus control unit 134 and the exposure calculation unit 135 may perform these operations for each piece of obtained image data or at predetermined time intervals.

The display control unit 136 displays the image data processed by the control and calculation unit 124 on the display unit 151, and also enables changing the image and menu displayed on the display unit 151 in response to a user operation. The display control unit 136 can also superimpose information (e.g., a frame or a marker) representing the tracking target object region, for example, on the live view image and display the resulting image on the display unit 151.

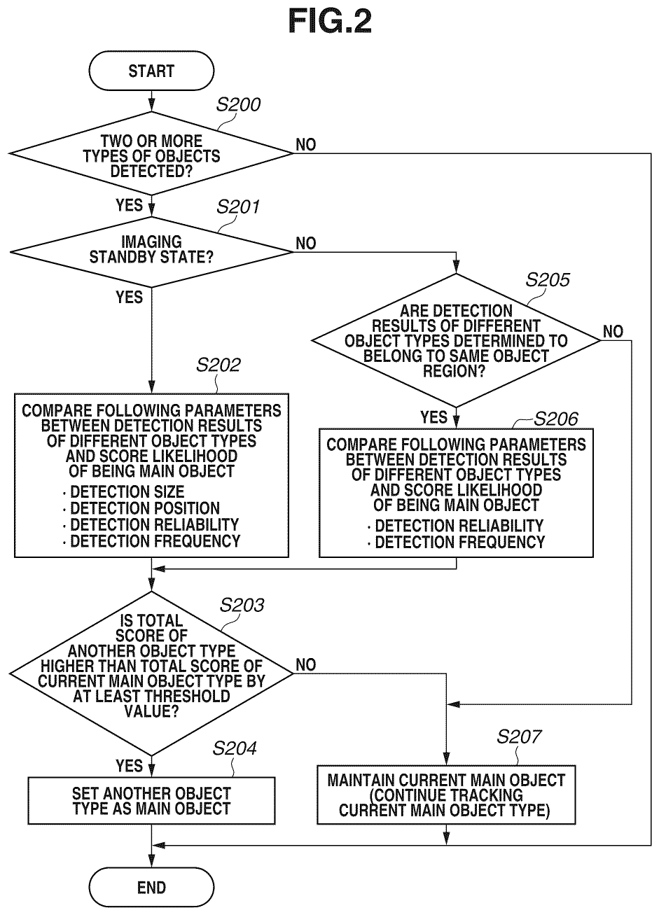

A procedure for main object re-selection processing by the main object determination unit 132 according to the present exemplary embodiment will be described with reference to FIGS. 2, 3A to 3C, and 4A to 4D.

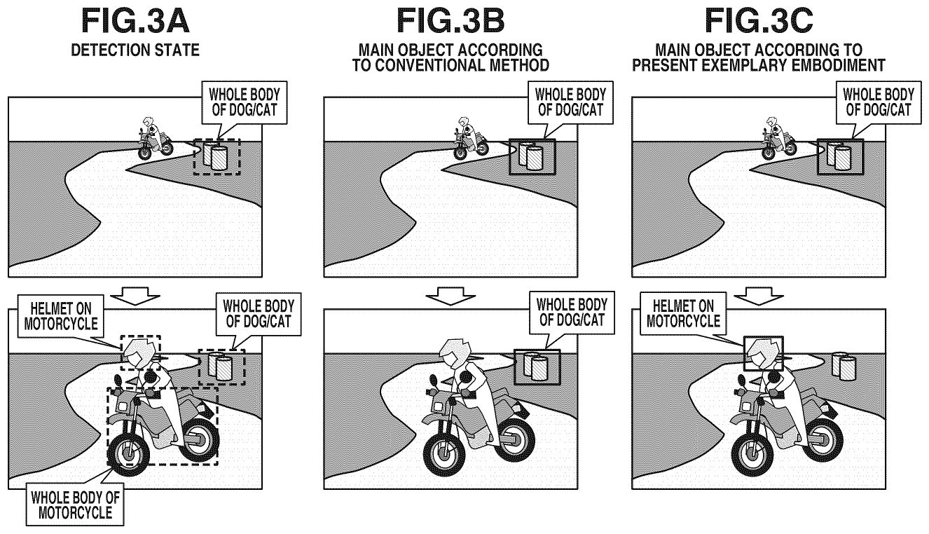

The behavior of the imaging apparatus in the imaging standby state, i.e., the state where the user does not press the operation unit 161 (the release switch in the present exemplary embodiment) will be described as an example with reference to a specific example of a scene illustrated in FIGS. 3A to 3C. Referring to FIG. 3A, when a motorcycle approaching from a distance has entered the angle of view of the imaging apparatus, the motorcycle is not initially detectable because the motorcycle is too small, and a roadside structure is erroneously detected as the whole body of a dog or cat. As the motorcycle approaches and increases in size, the whole body of the motorcycle and a helmet on the motorcycle become detectable properly, but the roadside structure is still erroneously detected as the whole body of a dog or cat. In a conventional main object selection method without re-selection of a main object, the roadside structure, which is only initially detected, is selected as a dog or cat as the main object as illustrated in FIG. 3B. Then, as long as the erroneous detection stably continues, the structure is continuously tracked as the main object even after the motorcycle becomes detectable. On the other hand, with the configuration according to the present exemplary embodiment, when the motorcycle becomes detectable, the motorcycle can be re-selected as the main object as illustrated in FIG. 3C.

A flowchart of processing for enabling the re-selection of the main object as illustrated in FIG. 3C will be described with reference to FIG. 2. The processing of the flowchart in FIG. 2 proceeds when the components operate under the control of the control and calculation unit 124.

In step S200, the main object determination unit 132 determines whether two or more types of objects are detected by the detection unit 131. Two types mean that, for example, a dog or cat and a motorcycle are detected as different types based on different dictionaries. Different parts in the same type of object, such as the eyes of the dog or cat and the whole body thereof, are not counted as two types. If two or more types of objects are detected (YES in step S200), the processing proceeds to step S201. If two or more types of objects are not detected (NO in step S200), the main object determination unit 132 terminates the processing. Referring to the example of scene illustrated in FIG. 3A to 3C, the dog or cat and the motorcycle are detected when the motorcycle is approaching, and thus the processing proceeds to step S201.

In step S201, the main object determination unit 132 determines the imaging state of the imaging apparatus. If the imaging apparatus is in the imaging standby state, i.e., the state where the user does not press the operation unit 161 (the release switch in the present exemplary embodiment) (YES in step S201), the processing proceeds to step S202. If the imaging apparatus is in a state where, after the focus adjustment operation is performed by a user operation, i.e., after the user starts focus adjustment to an object by pressing the release switch, the user holds down the release switch (to maintain the half-press state) (NO in step S201), the processing proceeds to step S205. The processing in the imaging standby state will now be described with reference to step S202.

In step S202, the main object determination unit 132 compares parameters related to the likelihood of being the main object between the detection results of different types of objects, and scores the likelihood of being the main object (i.e., calculates an evaluation value) for each of the objects. Then, the processing proceeds to step S203.

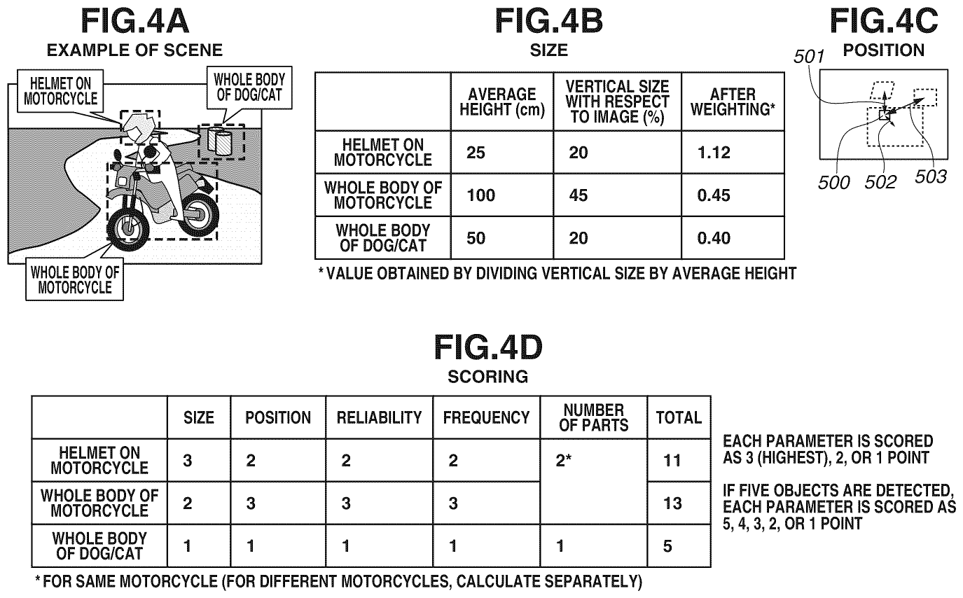

An example of calculations for scoring the likelihood of being the main object in the scene illustrated in FIGS. 3A to 3C will be described with reference to FIGS. 4A to 4D.

Assume a situation where, while the motorcycle intended to be imaged by the user is far, the detection unit 131 erroneously detects the roadside structure as a dog or cat and is tracking the structure. As the motorcycle increases in size as illustrated in FIG. 4A, the detection unit 131 becomes able to detect the whole body of the motorcycle and the helmet on the motorcycle in addition to the roadside structure. At this time, the main object determination unit 132 compares the detection size, the detection position, the detection reliability, the detection frequency, and the number of parts, as the parameters related to the likelihood of being the main object, between the detection result of the dog or cat and the detection result of the motorcycle. While, in the present example, the main object determination unit 132 compares a set of these five parameters, the parameters are not limited thereto. Depending on the calculation load on the main object determination unit 132, the number of parameters may be reduced, or there may be provided additional parameters related to the likelihood of being the main object, such as the ratio of vector matching with the framing direction. For each type of object, the main object determination unit 132 adds the scores of the parameters to calculate the total score (the evaluation value) and determines the likelihood of being the main unit.

When comparing the size between the detection results of different types of objects, the main object determination unit 132 may simply compare the detection frame size or the detection area between the objects. However, it is more desirable to perform scoring (weighting) in consideration of a relative difference such as a difference in original size between the objects. Referring to FIG. 4B, for example, the average heights of the helmet on the motorcycle, the whole body of the motorcycle, and the whole height of the dog or cat are 25 cm, 100 cm, and 50 cm, respectively, and the vertical sizes thereof with respect to the image in which these objects are detected are 20%, 45%, and 20% of the vertical angle of view, respectively. In this case, values obtained by dividing the vertical sizes by the average heights are 1.12, 0.45, and 0.40, respectively, and are used for comparison. The scores may be obtained by normalization, but in the present exemplary embodiment, the scoring is performed as follows. The highest score is simply set to be equal to the number of detected objects, and the scores are sequentially decremented by one (the lowest score is 1). Referring to FIG. 4B, the helmet on the motorcycle, the whole body of the motorcycle, and the whole body of the dog or cat are scored as 3, 2, and 1 point, respectively.

A scoring method related to the position of each detected object will be described with reference to FIG. 4C. In the example of FIG. 4C, the main object determination unit 132 compares the distances from a preset AF area 500 selected by the user to the respective detection targets so that the user's intention is reflected as much as possible. In a case where the AF area 500 selected by the user is the entire image, the main object determination unit 132 compares the distances from the center point of the image to the detection targets. For example, based on center coordinates of the AF area 500 selected by the user, the main object determination unit 132 compares a distance 501 to center coordinates of the detection area of the helmet on the motorcycle, a distance 502 to center coordinates of the detection area of the whole body of the motorcycle, and a distance 503 to center coordinates of the detection area of the whole body of the dog or cat. In the present example, the distances 502, 501, and 503 are smaller in this order, and thus the whole body of the motorcycle, the helmet on the motorcycle, and the whole body of the dog or cat are scored as 3, 2, and 1 point, respectively. The detection reliability, which indicates the likelihood of detection, and the detection frequency, which is the number of times of detection between three frames including the scene, are each scored as 3 (highest), 2, or 1 point. Referring to the scene in FIG. 4A where both the whole body of the motorcycle and the helmet on the motorcycle are detected whereas only the whole body of the dog or cat is detected among the eyes, face, and whole body thereof which are detectable, the number of parts, i.e., the number of detected parts is scored as 2 points for the motorcycle and 1 point for the dog or cat. However, this applies to a case where the whole body of the motorcycle and the helmet on the motorcycle are determined to belong to the same motorcycle. If the whole body and the helmet are away from each other and determined to belong to different motorcycles, these are each scored as 1 point.

In step S203, the main object determination unit 132 compares the total score of the detection result of the object type currently determined as the main object (which is also referred to as the current main object type) with the total score of the detection result of another object type. If the total score of another object type is higher than the total score of the current main object type by at least a threshold value (YES in step S203), the processing proceeds to step S204. In step S204, the main object determination unit 132 resets, as the main object, another object type different from the current main object type, and ends the processing. If the total score of another object type is not higher than the total score of the current main object type by at least the threshold value (NO in step S203), the processing proceeds to step S207. In step S207, the main object determination unit 132 maintains the object type currently determined as the main object, and ends the processing.

FIG. 4D illustrates a result of comparing the total score, which is the sum of the scores of the detection size, the detection position, the detection reliability, the detection frequency, and the number of parts, between detected objects. As the result of the comparison, the total score of the whole body of the motorcycle is higher than the total score of the whole body of the dog or cat by 8 points. For example, in a case where the threshold value for determining whether there is a difference between the total scores is set to 3 (because the majority of the number of parameters, i.e., 5, is 3), the difference between the total score of the whole body of the motorcycle and the total score of the whole body of the dog or cat is 8 which is larger than 3. Thus, the main object determination unit 132 changes the type of the main object from the whole body of the dog or cat to the helmet on the motorcycle as illustrated in FIG. 3C. The threshold value for determining whether there is a difference between the total scores is defined to prevent the main object from being frequently changed if there is an object having almost the same total score as that of the current main object. In the present example, the helmet on the motorcycle is set as the main object, whereas the total score of the whole body of the motorcycle is highest.

This is because the detection algorithm according to the present exemplary embodiment gives a higher priority to the detection of a smaller part in objects closer to the focus position of the object intended by the user. The configuration according to the present exemplary embodiment may not necessarily include such a detection algorithm.

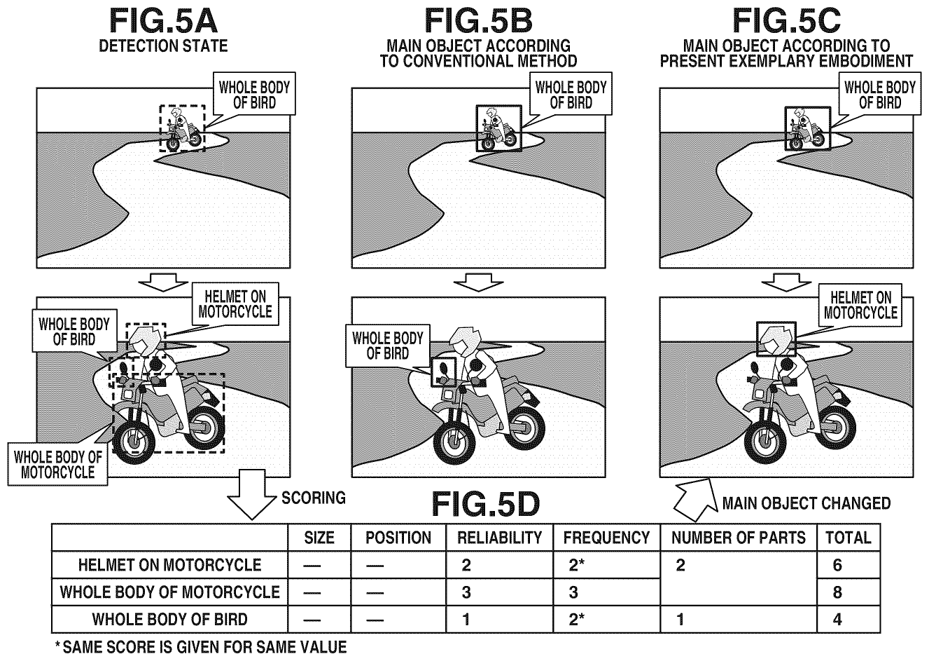

Next, the behavior of the imaging apparatus in the state after the user starts the focus adjustment by half-pressing the release switch (by entering the half-press state) will be described as an example with reference to a specific example of a scene illustrated in FIGS. 5A to 5C. The pressing operation in this case corresponds to the “imaging preparation instruction”. After performing the pressing operation (i.e., issuing the imaging preparation instruction), if the main object determined by the imaging apparatus is the intended imaging target, the user further presses the release switch to enter the full-press state, so that the “imaging start instruction” can be issued.

Referring to FIG. 5A, when a motorcycle approaching from a distance has entered the angle of view of the imaging apparatus, the detection unit 131 initially erroneously detects the motorcycle as a bird and does not detect the motorcycle as a motorcycle. As the motorcycle approaches and increases in size, the whole body of the motorcycle and the helmet on the motorcycle become detectable properly, but the vicinity of the mirror and handle of the motorcycle is still erroneously detected as the whole body of a bird. In the conventional main object selection method without the re-selection of the main object, the motorcycle is tracked as a bird which is only initially detected, as illustrated in FIG. 5B. Then, as long as the erroneous detection continues with a certain degree of stability, the result of the erroneous detection of the bird is continuously selected even after the motorcycle becomes detectable. More specifically, although the user actually expects the vicinity of the helmet to be in focus, an operation to focus on the vicinity of the handle is performed. On the other hand, as illustrated in FIG. 5C, the configuration according to the present exemplar embodiment enables re-selecting the motorcycle as the main object after the motorcycle becomes detectable as a motorcycle.

The examples of FIGS. 5A to 5C assume the scene where, after starting the focus adjustment operation by pressing the release switch, the user maintains the half-press state of the release switch. Thus, after steps S200 and S201, the processing proceeds to step S205 unlike the examples of FIGS. 3A to 3C.

In step S205, the main object determination unit 132 determines whether the detection result of an object type, which is not the current main object, belongs to the same object region as that of the detection result of the current main object type. In other words, the main object determination unit 132 determines whether the detection position of the object, which is not the current main object, exists in the detection region of the current main object type. Because the user holds down the release switch (to maintain the half-press state) after starting the focus adjustment with a user operation, at least the object currently being tracked is considered to be the object intended by the user. Thus, it is desirable not to select a detection result in regions other than the detection region of the object being tracked. A known method such as a distance-based technique is used as the method for determining whether the detection result of an object type, which is not the current main object, belongs to the same object region as that of the detection result of the current main object type. This technique determines that, for example, an object belongs to the same object region as that of the current main object if the object is within a certain distance from the current main object, i.e., 40% or less of the horizontal distance in the image. If there is an object type determined to belong to the same object region as that of the current main object type (YES in step S205), the processing proceeds to step S206. If there is no object type determined to belong to the same object region as that of the current main object type (NO in step S205), the processing proceeds to step S207 and then the processing ends. Referring to the examples of FIGS. 5A to 5C, the center of the helmet on the motorcycle and the center of the whole body of the motorcycle are within a certain distance from the detection position of the bird as the current main object, i.e., 40% or less of the horizontal distance in the image. Thus, these objects are determined to belong to the same object region as that of the current main object. Then, the processing proceeds to step S206.

In step S206, the main object determination unit 132 compares the parameters related to the likelihood of being the main object between the detection results of different types of objects, and scores the likelihood of being the main object for each of the objects. Then, the processing proceeds to step S203.

An example of calculations for scoring the likelihood of being the main object in the scene illustrated in FIGS. 5A to 5C will be described with reference to FIG. 5D. In this example, unlike step S202, the parameters other than the size and the position are used as parameters for scoring the likelihood of being the main object. Because the user holds down the release switch (to maintain the half-press state) after starting the focus adjustment with a user operation, at least the object currently being caught is considered to be the object intended by the user. Thus, if a detection result is determined to belong to the same object region as that of the object being caught, the detection result can be determined as a selection target regardless of the size and the position.

In the example of FIG. 5D, similarly to step S202, the main object determination unit 132 scores the detection reliability, the detection frequency, and the number of detected parts. If the value of any of these parameters is the same between the objects, the same score is given thereto like the score of the detection frequency. Assume that, as a result of the calculation, the total score of the whole body of the motorcycle is 8 points, and the total score of the whole body of the bird is 4 points. In this case, the total score of the whole body of the motorcycle is higher than the total score of the whole body of the bird by 4 points. More specifically, because the difference between the total scores is equal to or larger than a threshold value of 2 (which is the majority of the number of parameters, i.e., 3) (YES in step S203), the processing proceeds to step S204. In step S204, the main object determination unit 132 changes the main object from the bird to the motorcycle, and ends the processing.

In the above-described example, the parameters used for scoring the likelihood of being the main object are assumed to be equal to each other. Alternatively, the parameters to be used may be differentiated depending on the combination of object types, or weighting may be performed between the parameters. For example, in a case where the current main object is a bird, another detected object is a person, and it is known that the head of a person is likely to be detected erroneously because of the characteristics of a bird dictionary, the priorities of the size and the position may be lowered. Also, regarding the detection frequency and the number of parts, detection results may be weighted based on the difference in detection performance between dictionaries. For example, in a case where the detection performance of a person dictionary is 90%, and the detection performance of the bird dictionary is 80%, the detection result of the person may be given a higher priority by weighting the detection result of the bird.

As described above, the present exemplary embodiment makes it possible to provide an imaging apparatus capable of detecting and tracking a main object while suppressing erroneous detection in a state where various types of objects are set as detection targets.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-137539, filed Aug. 31, 2022, which is hereby incorporated by reference herein in its entirety.

What is claimed is:

1. An image processing apparatus comprising:
a memory device that stores a set of instructions; and
at least one processor that executes the set of instructions to function as:
an acquisition unit configured to acquire an image;
a detection unit configured to detect objects of different types;
a main object determination unit configured to determine an object as a main object based on a result of the detection by the detection unit; and
a tracking unit configured to track the object determined as the main object by the main object determination unit,
wherein, in a state where the object being tracked is continuously detected by the detection unit, in a case where an object of a type different from a type of the object being tracked is detected in addition to the object being tracked, the main object determination unit re-determines which type of object is the main object.

2. The image processing apparatus according to claim 1, further comprising a display control unit configured to control a display unit configured to display the image,
wherein the display control unit controls the display unit to display information indicating the object being tracked by the tracking unit while superimposing the information on the image.

3. The image processing apparatus according to claim 1,
wherein, in the state where the object being tracked is continuously detected by the detection unit, in the case where the object of the type different from the type of the object being tracked is detected in addition to the object being tracked, the main object determination unit calculates an evaluation value of each of the object being tracked and the object of the type different from the type of the object being tracked, and
wherein, in a case where the evaluation value of the object of the type different from the type of the object being tracked is larger than the evaluation value of the object being tracked by a predetermined value, the main object determination unit changes the type corresponding to the main object.

4. The image processing apparatus according to claim 3, wherein the evaluation value is calculated based on parameters including at least one of a detection size, a detection position, detection reliability, detection frequency, and a number of detected parts.

5. The image processing apparatus according to claim 4, wherein the evaluation value increases with a decreasing distance between the detection position and a center of the image or a focus adjustment region set by a user.

6. The image processing apparatus according to claim 4, wherein the evaluation value is calculated based on the detection size that is subjected to weighting in consideration of a relative size difference between the object being tracked and the object of the type different from the type of the object being tracked.

7. The image processing apparatus according to claim 4, wherein the evaluation value increases as the detection reliability increases.

8. The image processing apparatus according to claim 4, wherein the evaluation value increases as the detection frequency increases.

9. The image processing apparatus according to claim 4, wherein the evaluation value increases as the number of detected parts increases.

10. The image processing apparatus according to claim 1, wherein the detection unit detects at least two of a person, an animal, and a vehicle as the objects of the different types.

11. An imaging apparatus comprising:
an image sensor configured to output an image; and
the image processing apparatus according to claim 1.

12. The imaging apparatus according to claim 11,
wherein, in the state where the object being tracked is continuously detected by the detection unit, in the case where the object of the type different from the type of the object being tracked is detected in addition to the object being tracked, the main object determination unit calculates an evaluation value of each of the object being tracked and the object of the type different from the type of the object being tracked,
wherein, in a case where the evaluation value of the object of the type different from the type of the object being tracked is larger than the evaluation value of the object being tracked by a predetermined value, the main object determination unit changes the type corresponding to the main object, and
wherein, in a state where an imaging preparation operation of a user is received, the evaluation value is calculated based on parameters including at least one of detection reliability, detection frequency, and a number of detected parts.

13. A method for controlling an image processing apparatus, the method comprising:
acquiring an image;
detecting objects of different types;
determining an object as a main object based on a result of the detecting; and
tracking the object determined as the main object,
wherein, in a state where the object being tracked is continuously detected, in a case where an object of a type different from a type of the object being tracked is detected in addition to the object being tracked, which type of object is the main object is re-determined.

14. A non-transitory computer-readable storage medium storing a program for causing a computer to perform a method for controlling an image processing apparatus, the method comprising:
acquiring an image;
detecting objects of different types;
determining an object as a main object based on a result of the detecting; and
tracking the object determined as the main object,
wherein, in a state where the object being tracked is continuously detected, in a case where an object of a type different from a type of the object being tracked is detected in addition to the object being tracked, which type of object is the main object is re-determined.
